(19) United States
(12) Patent Application Publication
(10) Pub. No.: US 2017/0168966 A1
(43) Pub. Date: Jun. 15, 2017

(54) OPTIMAL LATENCY PACKETIZER FINITE STATE MACHINE FOR MESSAGING AND INPUT/OUTPUT TRANSFER INTERFACES

(71) Applicant: QUALCOMM Incorporated, San Diego, CA (US)

(72) Inventors: Lalan Jee Mishra, San Diego, CA (US); Radu Pitigoi-Aron, San Diego, CA (US); Richard Dominic Wietfeldt, San Diego, CA (US)

(21) Appl. No.: 15/348,353

(22) Filed: Nov. 10, 2016

Related U.S. Application Data
(60) Provisional application No. 62/265,599, filed on Dec. 10, 2015.

(51) Int. Cl. G06F 13/16; G06F 13/364; G06F 13/12; G06F 13/40; H04W 4/00; G06F 13/42

(52) U.S. Cl. CPC G06F 13/161; H04W 4/008; G06F 13/4282; G06F 13/128; G06F 13/4022; G06F 13/364; H04W 84/12

(57) ABSTRACT

Systems, methods, and apparatus for communication virtualized general-purpose input/output (GPIO) signals over a serial communication link A method performed at a transmitting device coupled to a communication link includes encoding virtual GPIO signals or messages into a data packet, determining a maximum latency requirement for transmitting the data packet over the communication link, providing a command code header indicating a packet type to be used for transmitting the data packet over the communication link, and transmitting the command code header and the data packet over the communication link in a packet selected to satisfy the maximum latency requirement. A protocol for transmitting the data packet may be determined based on the maximum latency requirement and one or more attributes of protocols available for use on the communication link. In one example, the communication link includes a serial bus and the available protocols include I2C, I3C, and/or RFFE protocols.

### CROSS-REFERENCE TO RELATED APPLICATIONS

The present application for patent claims priority to Provisional Application No. 62/265,599, filed Dec. 10, 2015 and entitled “Finite State Machine For Serial Messaging And I/O Configuration With Optimal Latency,” which application is assigned to the assignee hereof and hereby expressly incorporated by reference herein.

### TECHNICAL FIELD

The present disclosure relates generally to serial communication and input/output pin configuration and, more particularly, to optimizing a finite state machine configured for optimal latency for serial messaging and input/output pin configuration.

### BACKGROUND

Mobile communication devices may include a variety of components including circuit boards, integrated circuit (IC) devices and/or System-on-Chip (SoC) devices. The components may include processing devices, user interface components, storage and other peripheral components that communicate through a serial bus. General-purpose serial interfaces known in the industry, including the Inter-Integrated Circuit (I2C or I²C) serial bus and its derivatives and alternatives, including interfaces defined by the Mobile Industry Processor Interface (MIPI) Alliance, such as I3C and the Radio Frequency Front-End (RFFE) interface.

In one example, the I2C serial bus is a serial single-ended computer bus that was intended for use in connecting low-speed peripherals to a processor. Some interfaces provide multi-master busses in which two or more devices can serve as a bus master for different messages transmitted on the serial bus. In another example, the RFFE, interface defines a communication interface for controlling various radio frequency (RF) front-end devices, including power amplifier (PA), low-noise amplifiers (LNAs), antenna tuners, filters, sensors, power management devices, switches, etc. These devices may be collocated in a single IC device or provided in multiple IC devices. In a mobile communications device, multiple antennas and radio transceivers may support multiple concurrent RF links

In many instances, a number of command and control signals are employed to connect different component devices in mobile communication devices. These connections consume precious general-purpose input/output (GPIO) pins within the mobile communication devices and it would be desirable to replace the physical interconnects with signals carried in information transmitted over existing serial data links. However, the serial data links are associated with latencies that can prevent conversion of physical command and control signals to virtual signals, particularly in real-time embedded system applications supported by mobile communication devices that define firm transmission deadlines.

As mobile communication devices continue to include a greater level of functionality, improved serial communication techniques are needed to support low-latency transmissions between peripherals and application processors.

### SUMMARY

Certain aspects of the disclosure relate to systems, apparatus, methods and techniques that can provide optimized low-latency communications between different devices such that GPIO signals may be carried as virtual signals. A virtual GPIO finite state machine (VGI FSM) is provided that can optimize transmission latency for virtual GPIO signals and corresponding configuration parameters for GPIO pins. In some examples, the VGI FSM can determine the type of packet to be used for transmitting virtual GPIO signals. In some examples, the VGI FSM can determine the protocol to be used for transmitting virtual GPIO signals.

In various aspects of the disclosure, a method performed at a transmitting device includes encoding virtual GPIO signals or messages into a data packet to be transmitted over a communication link, determining a maximum latency requirement for transmitting the data packet over the communication link, providing a command code header indicating a packet type to be used for transmitting the data packet over the communication link, and transmitting the command code header and the data packet over the communication link to at least one peripheral device in a packet that has a type indicated by the command code header. The virtual GPIO signals may represent state information related to a physical GPIO connector. The packet type may be selected to satisfy the maximum latency requirement.

In certain aspects, the communication link includes a serial bus and the method may include determining a protocol to be used for transmitting the data packet based on the maximum latency requirement and one or more attributes of a plurality of protocols available for use on the serial bus. The method may include configuring the command code header to indicate the protocol to be used for transmitting the data packet. The plurality of protocols available for use on the serial bus may include an I2C protocol, an I3C protocol, or an RFFE protocol.

In one aspect, the method may include determining a mode of operation for the communication link to be used when transmitting the data packet based on the maximum latency requirement and one or more attributes of a plurality of modes of operation associated with the communication link. The method may include configuring the command code header to indicate the mode of operation to a physical layer circuit to be used for transmitting the data packet.

In certain aspects, the communication link includes a wireless communication link, and the method may include determining a protocol to be used for transmitting the data packet based on the maximum latency requirement and one or more attributes of a plurality of protocols available for use on the wireless communication link. The method may include configuring the command code header to indicate the protocol to be used for transmitting the data packet. The plurality of protocols may include a Bluetooth protocol, a protocol associated with a wireless local area network, or a protocol associated with a cellular wireless network.

In some aspects, the data packet includes virtual GPIO signals corresponding to configuration parameters for GPIO pins in the at least one peripheral device. The configuration parameters may include slew rate parameters, or drive strength parameters.

In various aspects of the disclosure, an apparatus includes a physical layer circuit adapted to couple the apparatus to a communication link, a packetizer configured to encode messages or virtual GPIO signals in a data packet to be transmitted over the communication link, and a finite state machine. The finite state machine may be configured to determine a maximum latency requirement for transmitting the data packet over the communication link, and provide a command code to the packetizer, the command code indicating a packet type to be used for transmitting the data packet over the communication link. The packet type may be selected to satisfy the maximum latency requirement. The packetizer may be configured to provide a packet comprising the data packet and the command code to the physical layer circuit. The physical layer circuit may be configured to transmit the packet over the communication link to at least one peripheral device.

In certain aspects, the communication link includes a serial bus, and the finite state machine may be configured to determine a protocol to be used for transmitting the data packet based on the maximum latency requirement and one or more attributes of a plurality of protocols available for use on the serial bus, and configure the command code to indicate the protocol to be used for transmitting the packet. The plurality of protocols may include an I2C protocol, an I3C protocol or an RFFE protocol.

In one aspect, the finite state machine may be configured to determine a mode of operation for the communication link to be used when transmitting the data packet based on the maximum latency requirement and one or more attributes of a plurality of modes of operation associated with the communication link. The finite state machine may be adapted to configure the command code header to indicate the mode of operation to be used for transmitting the data packet to the physical layer circuit.

In some aspects, the communication link includes a wireless communication link, and the finite state machine may be configured to determine a protocol to be used for transmitting the data packet based on the maximum latency requirement and one or more attributes of a plurality of protocols available for use on the wireless communication link. The finite state machine may be adapted to configure the command code header to indicate the protocol to be used for transmitting the data packet. The plurality of protocols may include a Bluetooth protocol, a protocol associated with a wireless local area network, or a protocol associated with a cellular wireless network.

In certain aspects, the data packet includes virtual GPIO signals corresponding to configuration parameters for GPIO pins in the at least one peripheral device. The configuration parameters may include slew rate parameters and/or drive strength parameters.

In various aspects, an apparatus includes means for encoding virtual GPIO signals or messages into a data packet to be transmitted over a communication link, means for determining a maximum latency requirement for transmitting the data packet over the communication link, means for providing a command code header indicating a packet type to be used for transmitting the data packet over the communication link. The packet type may be selected to satisfy the maximum latency requirement. The apparatus may include means for transmitting the command code header and the data packet over the communication link to at least one peripheral device in a packet that has a type indicated by the command code header. The virtual GPIO signals may represent state information related to a physical GPIO connector.

In certain aspects, the communication link includes a serial bus, and the means for determining a maximum latency requirement may be configured to determine a protocol to be used for transmitting the data packet based on the maximum latency requirement and one or more attributes of a plurality of protocols available for use on the serial bus, and configure the command code header to indicate the protocol to be used for transmitting the data packet. The plurality of protocols available for use on the serial bus may include an I2C protocol, an I3C protocol or an RFFE, protocol.

In some aspects, the means for determining a maximum latency requirement is configured to determine a mode of operation for the communication link to be used when transmitting the data packet based on the maximum latency requirement and one or more attributes of a plurality of modes of operation associated with the communication link, and configure the command code header to indicate the mode of operation to a physical layer circuit to be used for transmitting the data packet.

In certain aspects, the communication link includes a wireless communication link, and the means for determining a maximum latency requirement may be configured to determine a protocol to be used for transmitting the data packet based on the maximum latency requirement and one or more attributes of a plurality of protocols available for use on the wireless communication link, and configure the command code header to indicate the protocol to be used for transmitting the data packet. The plurality of protocols may include a Bluetooth protocol, a protocol associated with a wireless local area network, or a protocol associated with a cellular wireless network.

In various aspects of the disclosure, a processor readable storage medium is disclosed. The storage medium may be a non-transitory storage medium and may store code that, when executed by one or more processors, causes the one or more processors to encode virtual GPIO signals or messages into a data packet to be transmitted over a communication link, determine a maximum latency requirement for transmitting the data packet over the communication link, provide a command code header indicating a packet type to be used for transmitting the data packet over the communication link, and transmit the command code header and the data packet over the communication link to at least one peripheral device in a packet that has a type indicated by the command code header. The virtual GPIO signals may represent state information related to a physical GPIO connector. The packet type may be selected to satisfy the maximum latency requirement.

In certain aspects, the communication link includes a serial bus, and the instructions may cause the processing circuit to determine a protocol to be used for transmitting the data packet based on the maximum latency requirement and one or more attributes of a plurality of protocols available for use on the serial bus, and configure the command code header to indicate the protocol to be used for transmitting the data packet. The plurality of protocols available for use on the serial bus may include an I2C protocol, an I3C protocol or a radio frequency front-end protocol.

In some aspects, the instructions may cause the processing circuit to determine a mode of operation for the communication link to be used when transmitting the data packet based on the maximum latency requirement and one or more attributes of a plurality of modes of operation associated with the communication link, and configure the command code header to indicate the mode of operation to a physical layer circuit to be used for transmitting the data packet.

In certain aspects, the communication link includes a wireless communication link, and the instructions may cause the processing circuit to determine a protocol to be used for transmitting the data packet based on the maximum latency requirement and one or more attributes of a plurality of protocols available for use on the wireless communication link, and configure the command code header to indicate the protocol to be used for transmitting the data packet. The plurality of protocols may include a Bluetooth protocol, a protocol associated with a wireless local area network, or a protocol associated with a cellular wireless network.

### BRIEF DESCRIPTION OF THE DRAWINGS

FIG. 1 illustrates an apparatus employing a data link between IC devices that is selectively operated according to one of plurality of available standards.

FIG. 2 illustrates a system architecture for an apparatus employing a data link between IC devices.

FIG. 3 illustrates a device that employs an RFFE bus to couple various radio frequency front-end devices.

FIG. 4 illustrates a device that employs an I3C bus to couple various front-end devices in accordance with certain aspects disclosed herein.

FIG. 5 illustrates an apparatus that includes an Application Processor and multiple peripheral devices that may be adapted according to certain aspects disclosed herein.

FIG. 6 illustrates an apparatus that has been adapted to support Virtual GPIO in accordance with certain aspects disclosed herein.

FIG. 7 illustrates examples of VGI broadcast frames according to certain aspects disclosed herein.

FIG. 8 illustrates examples of VGI directed frames according to certain aspects disclosed herein.

FIG. 9 illustrates configuration registers that may be associated with a physical pin according to certain aspects disclosed herein.

FIG. 10 illustrates certain aspects of a finite state machine that can support virtual GPIO in an apparatus in accordance with certain aspects disclosed herein.

FIG. 11 illustrates one example of an apparatus employing a processing circuit that may be adapted according to certain aspects disclosed herein.

FIG. 12 is a flowchart illustrating certain operations of an application processor adapted to cause slave devices to obtain multiple dynamic addresses in accordance with certain aspects disclosed herein.

FIG. 13 illustrates a first example of a hardware implementation for an apparatus adapted to respond to multiple dynamic addresses in accordance with certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the invention will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

### Overview

Devices that include multiple SoC and other IC devices often employ a serial bus to connect processors with modems and other peripherals. The serial bus may be operated in accordance with multiple protocols. In one example, the serial bus may be operated in accordance I2C, I3C, and/or RFFE protocols. According to certain aspects disclosed herein, GPIO pins and signals may be virtualized into GPIO state information that may be transmitted over a serial communication link Virtualized GPIO state information that may be transmitted over a variety of communication links, including links that include wired and links that include wireless communication links. For example, virtualized GPIO state information can be packetized or otherwise formatted for transmission over wireless networks including Bluetooth, Wireless LAN, cellular networks, etc. Examples involving wired communication links are described herein to facilitate understanding of certain aspects. These aspects invariably apply to implementations in which transmission of GPIO state information includes transmission over wireless networks.

A number of different protocol schemes may be used for communicating messaging and data over serial communication links Existing protocols have well-defined and immutable structures in the sense that their structures cannot be changed to optimize transmission latencies based on variations in use cases, and/or coexistence with other protocols, devices and applications. It is an imperative of real-time embedded systems that certain deadlines must be met. In certain real-time applications, meeting transmission deadlines is of paramount importance. When a common bus supports different protocols it is generally difficult or impossible to guarantee optimal latency under all use cases. In some examples, an I2C, I3C or RFFE serial communication bus may be used to tunnel different protocols with different latency requirements, different data transmission volumes and/or different transmission schedules.

According to certain aspects of the invention, an intelligent block provided between data sources (protocol units, for example) and physical layer circuits can guarantee optimal latency under all use cases. An intelligent finite state machine receives payloads from a plurality of sources. The payloads may be configured according to different protocols and for transmission over a specific type of physical layer circuit. The finite state machine may select a command code for a payload, where the selected command code corresponds to the source and/or physical layer circuit associated with the payload. The finite state machine may prioritize the payloads for transmission over a shared bus, in an order determined by priorities associated with the source of each payload and/or the content of the payload. For each payload, the finite state machine generates a transmission packet that has a command code header and serialized general purpose input/out (GPIO) state data, the GPIO state data representing physical signaling on a communication interface associated with the physical layer circuit corresponding to the payload.

Based on the use case, the finite state machine performs latency estimation to determine the optimal protocol to be used for the information (data, messaging, GPIO state data) to be transferred. A receiver can determine which protocol is carried in the payload based on the unique command code that was selected by the finite state machine from a pool of pre-defined and mutually-agreed command codes. The command code may be selected based on the command code index generated by a latency estimation block. The selected command codes along with the payload may then be sent to a packetizer block. The latency estimation block and packetizer block can be implemented in hardware, although some combination of hardware and software may be used in some examples:

Examples of Apparatus that Employ Serial Data Links

According to certain aspects, a serial data link may be used to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similar functioning device.

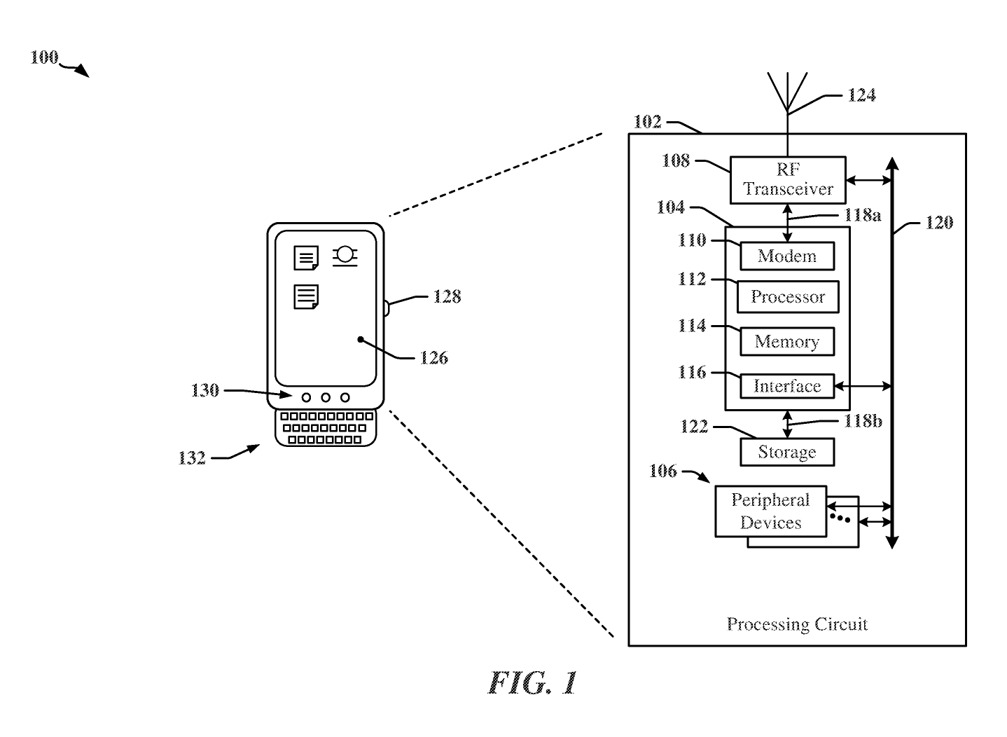

FIG. 1 illustrates an example of an apparatus 100 that may employ a data communication bus. The apparatus 100 may include an SoC a processing circuit 102 having multiple circuits or devices 104, 106 and/or 108, which may be implemented in one or more ASICs or in an SoC. In one example, the apparatus 100 may be a communication device and the processing circuit 102 may include a processing device provided in an ASIC 104, one or more peripheral devices 106, and a transceiver 108 that enables the apparatus to communicate through an antenna 124 with a radio access network, a core access network, the Internet and/or another network.

The ASIC 104 may have one or more processors 112, one or more modems 110, on-board memory 114, a bus interface circuit 116 and/or other logic circuits or functions. The processing circuit 102 may be controlled by an operating system that may provide an application programming interface (API) layer that enables the one or more processors 112 to execute software modules residing in the on-board memory 114 or other processor-readable storage 122 provided on the processing circuit 102. The software modules may include instructions and data stored in the on-board memory 114 or processor-readable storage 122. The ASIC 104 may access its on-board memory 114, the processor-readable storage 122, and/or storage external to the processing circuit 102. The on-board memory 114, the processor-readable storage 122 may include read-only memory (ROM) or random-access memory (RAM), electrically erasable programmable ROM (EEPROM), flash cards, or any memory device that can be used in processing systems and computing platforms. The processing circuit 102 may include, implement, or have access to a local database or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as the antenna 124, a display 126, operator controls, such as switches or buttons 128, 130 and/or an integrated or external keypad 132, among other components. A user interface module may be configured to operate with the display 126, keypad 132, etc. through a dedicated communication link or through one or more serial data interconnects.

The processing circuit 102 may provide one or more buses 118a, 118b, 120 that enable certain devices 104, 106, and/or 108 to communicate. In one example, the ASIC 104 may include a bus interface circuit 116 that includes a combination of circuits, counters, timers, control logic and other configurable circuits or modules. In one example, the bus interface circuit 116 may be configured to operate in accordance with communication specifications or protocols. The processing circuit 102 may include or control a power management function that configures and manages the operation of the apparatus 100.

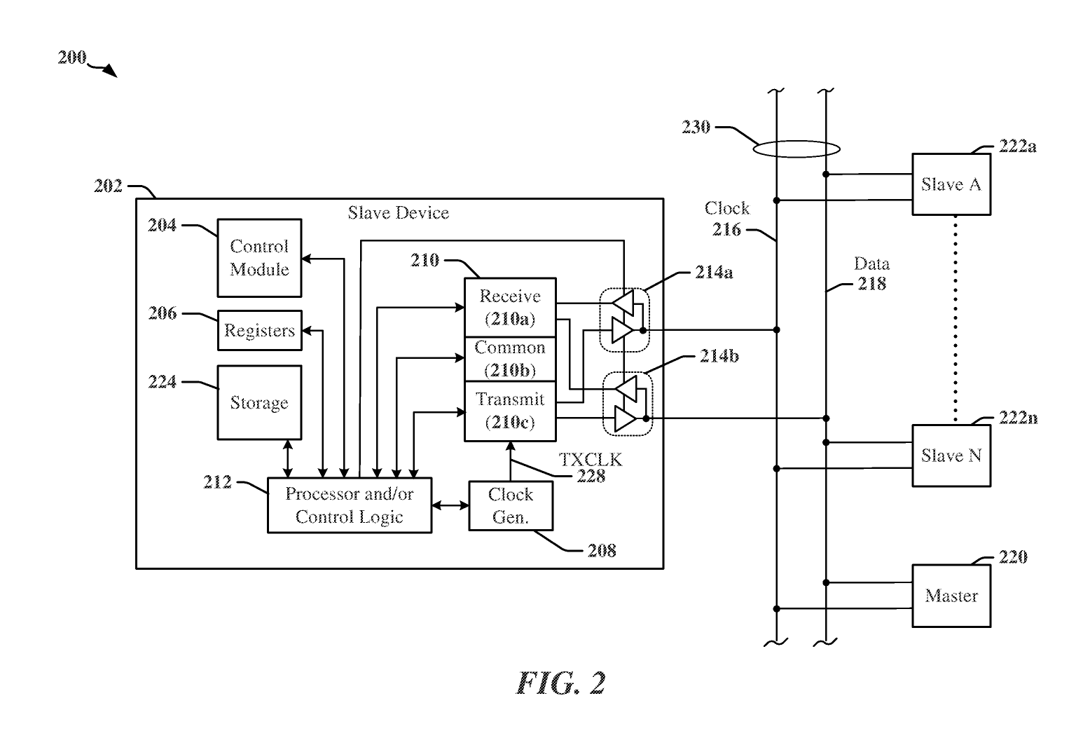

FIG. 2 illustrates certain aspects of an apparatus 200 that includes multiple devices 202, 220 and 222a-222n connected to a serial bus 230. The devices 202, 220 and 222a-222n may include one or more semiconductor IC devices, such as an applications processor, SoC or ASIC. Each of the devices 202, 220 and 222a-222n may include, support or operate as a modem, a signal processing device, a display driver, a camera, a user interface, a sensor, a sensor controller, a media player, a transceiver, and/or other such components or devices. Communications between devices 202, 220 and 222a-222n over the serial bus 230 is controlled by a bus master device 220. Certain types of bus can support multiple bus master devices 220.

The apparatus 200 may include multiple devices 202, 220 and 222a-222n that communicate when the serial bus 230 is operated in accordance with I2C, I3C or other protocols. At least one device 202, 222a-222n may be configured to operate as a slave device on the serial bus 230. In one example, a slave device 202 may be adapted to provide a control function 204. In some examples, the control function 204 may include circuits and modules that support a display, an image sensor, and/or circuits and modules that control and communicate with one or more sensors that measure environmental conditions. The slave device 202 may include configuration registers 206 or other storage 224, control logic 212, a transceiver 210 and line drivers/receivers 214a and 214b. The control logic 212 may include a processing circuit such as a state machine, sequencer, signal processor or general-purpose processor. The transceiver 210 may include a receiver 210a, a transmitter 210c and common circuits 210b, including timing, logic and storage circuits and/or devices. In one example, the transmitter 210c encodes and transmits data based on timing in one or more signals 228 provided by a clock generation circuit 208.

Two or more of the devices 202, 220 and/or 222a-222n may be adapted according to certain aspects and features disclosed herein to support a plurality of different communication protocols over a common bus, which may include an I2C and/or I3C protocol. In some instances, devices that communicate using the I2C protocol can coexist on the same 2-wire interface with devices that communicate using I3C protocols. In one example, the I3C protocols may support a mode of operation that provides a data rate between 6 megabits per second (Mbps) and 16 Mbps with one or more optional high-data-rate (HDR) modes of operation that provide higher performance. The I2C protocols may conform to de facto I2C standards providing for data rates that may range between 100 kilobits per second (kbps) and 3.2 Mbps. I2C and I3C protocols may define electrical and timing aspects for signals transmitted on the 2-wire serial bus 230, in addition to data formats and aspects of bus control. In some aspects, the I2C and I3C protocols may define direct current (DC) characteristics affecting certain signal levels associated with the serial bus 230, and/or alternating current (AC) characteristics affecting certain timing aspects of signals transmitted on the serial bus 230. In some examples, a 2-wire serial bus 230 transmits data on a first wire 218 and a clock signal on a second wire 216. In some instances, data may be encoded in the signaling state, or transitions in signaling state of the first wire 218 and the second wire 216.

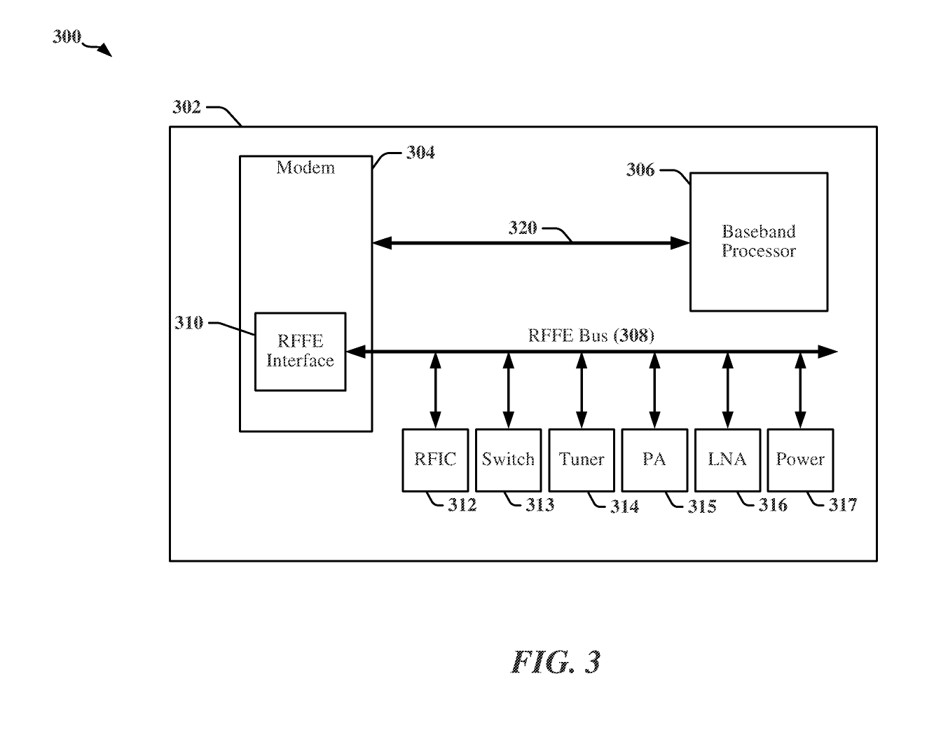

FIG. 3 is a block diagram 300 illustrating an example of a device 302 that employs an RFFE bus 308 to couple various front-end devices 312-317. A modem 304 may include an RFFE interface 310 that couples the modem 304 to the RFFE bus 308. The modem 304 may communicate with a baseband processor 306. The illustrated device 302 may be embodied in one or more of a mobile communication device, a mobile telephone, a mobile computing system, a mobile telephone, a notebook computer, a tablet computing device, a media player, a gaming device, a wearable computing and/or communications device, an appliance, or the like. In various examples, the device 302 may be implemented with one or more baseband processors 306, modems 304, multiple communications links 308, 320, and various other busses, devices and/or different functionalities. In the example illustrated in FIG. 3, the RFFE bus 308 may be coupled to an RF integrated circuit (RFIC) 312, which may include one or more controllers, and/or processors that configure and control certain aspects of the RF front-end. The RFFE, bus 308 may couple the RFIC 312 to a switch 313, an RF tuner 314, a power amplifier (PA) 315, a low noise amplifier (LNA) 316 and a power management module 317.

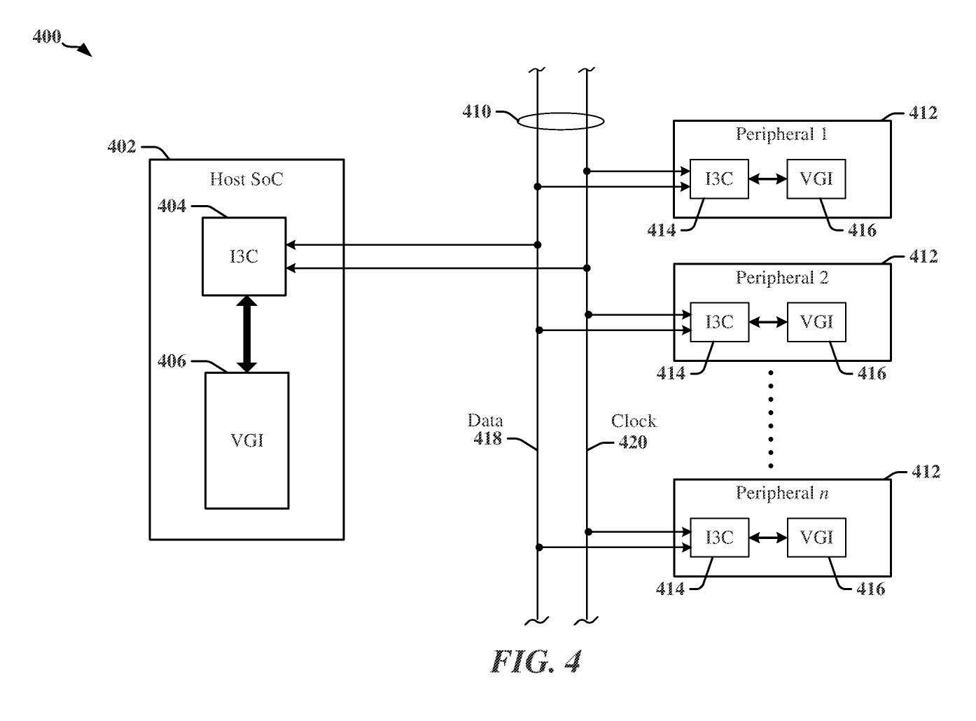

FIG. 4 illustrates an example of an apparatus 400 that uses an I3C bus to couple various devices including a host SoC 402 and a number of peripheral devices 412. The host SoC 402 may include a virtual GPIO finite state machine (VGI FSM 406) and an I3C interface 404, where the I3C interface 404 cooperates with corresponding I3C interfaces 414 in the peripheral devices 412 to provide a communication link between the host SoC 402 and the peripheral devices 412. Each peripheral device 412 includes a VGI FSM 416. In the illustrated example, communications between the SoC 402 and a peripheral device 412 may be serialized and transmitted over a multi-wire serial bus 410 in accordance with an I3C protocol. In other examples, the host SoC 402 may include other types of interface, including I2C and/or RFFE interfaces. In other examples, the host SoC 402 may include a configurable interface that may be employed to communicate using I2C, I3C, RFFE and/or another suitable protocol. In some examples, a multi-wire serial bus 410, such as an I2C or I3C bus, may transmit a data signal over a data wire 418 and a clock signal over a clock wire 420.

### Signaling Virtual GPIO Configuration Information

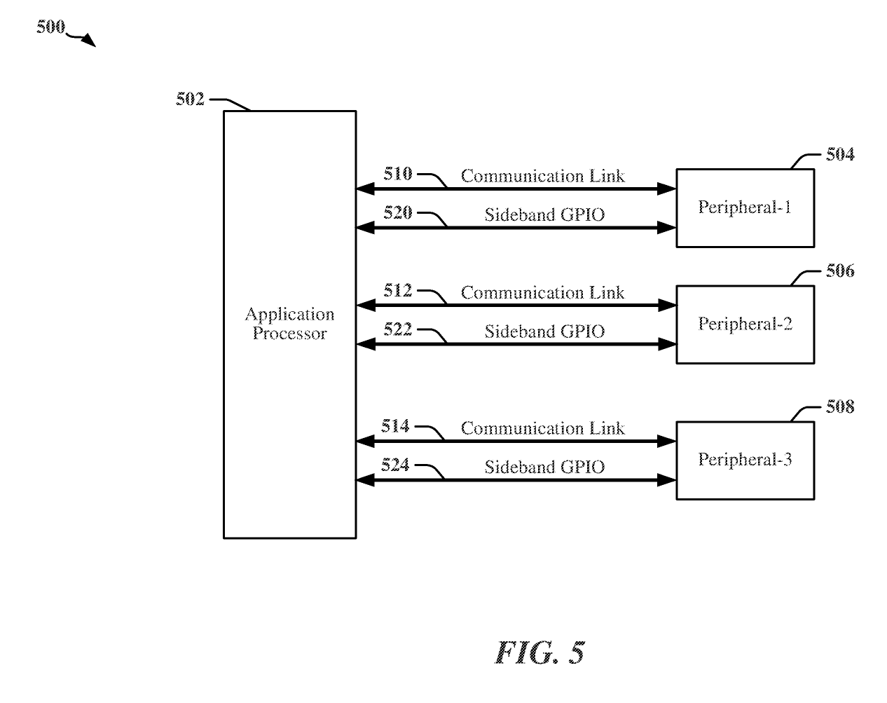

Mobile communication devices, and other devices that are related or connected to mobile communication devices, increasingly provide greater capabilities, performance and functionalities. In many instances, a mobile communication device incorporates multiple IC devices that are connected using a variety of communications links FIG. 5 illustrates an apparatus 500 that includes an Application Processor 502 and multiple peripheral devices 504, 506, 508. In the example, each peripheral device 504, 506, 508 communicates with the Application Processor 502 over a respective communication link 510, 512, 514 operated in accordance with mutually different protocols. Communication between the Application Processor 502 and each peripheral device 504, 506, 508 may involve additional wires that carry control or command signals between the Application Processor 502 and the peripheral devices 504, 506, 508. These additional wires may be referred to as sideband general purpose input/output (sideband GPIO 520, 522, 524), and in some instances the number of connections needed for sideband GPIO 520, 522, 524 can exceed the number of connections used for a communication link 510, 512, 514.

GPIO provides generic pins/connections that may be customized for particular applications. For example, a GPIO pin may be programmable to function as an output, input pin or a bidirectional pin, in accordance with application needs. In one example, the Application Processor 502 may assign and/or configure a number of GPIO pins to conduct handshake signaling or inter-processor communication (IPC) with a peripheral device 504, 506, 508 such as a modem. When handshake signaling is used, sideband signaling may be symmetric, where signaling is transmitted and received by the Application Processor 502 and a peripheral device 504, 506, 508. With increased device complexity, the increased number of GPIO pins used for IPC communication may significantly increase manufacturing cost and limit GPIO availability for other system-level peripheral interfaces.

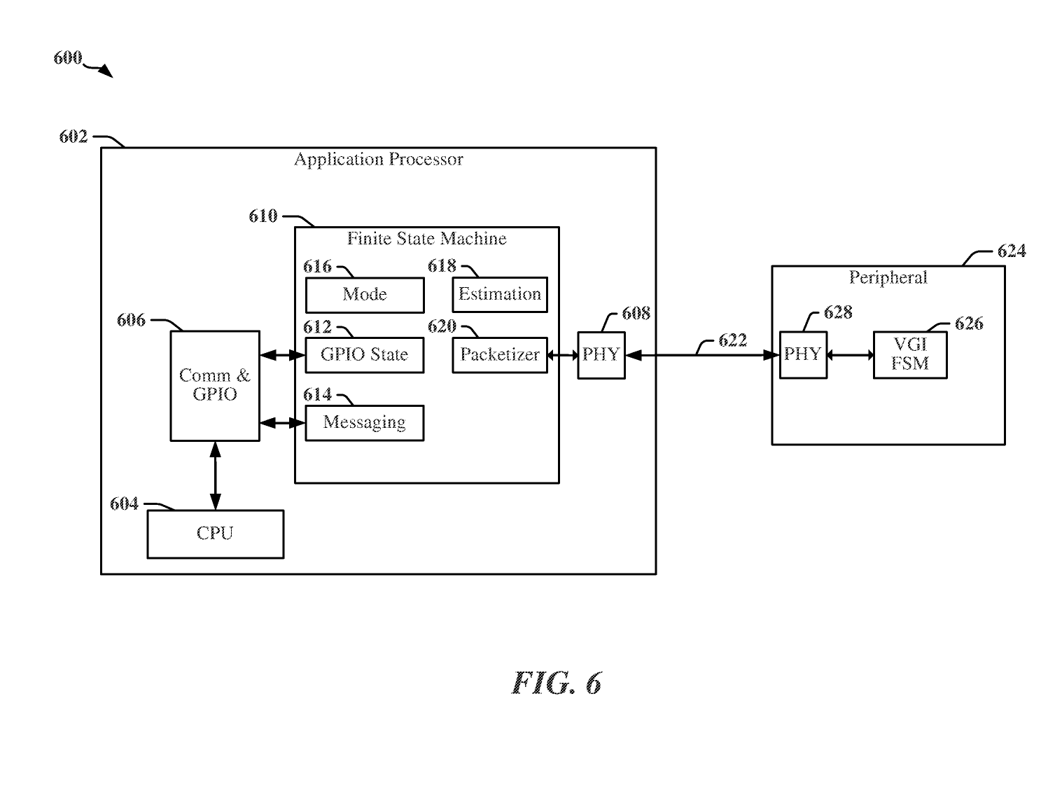

FIG. 6 illustrates an apparatus 600 that is adapted to support Virtual GPIO (VGI or VGMI) in accordance with certain aspects disclosed herein. VGI circuits and techniques can reduce the number of physical pins and connections used to connect an Application Processor 602 with a peripheral device 624. VGI enables a plurality of GPIO signals to be serialized into virtual GPIO signals that can be transmitted over a communication link 622. In one example, virtual GPIO signals may be encoded in packets that are transmitted over a communication link 622 that includes a multi-wire bus, including a serial bus. When the communication link 622 is provided as a serial bus, the receiving peripheral device 624 may deserialize received packets and may extract messages and virtual GPIO signals. A VGI FSM 626 in the peripheral device 624 may convert the virtual GPIO signals to physical GPIO signals that can be presented at an internal GPIO interface.

In another example, the communication link 622 may be a provided by a radio frequency transceiver that supports wireless communication using, for example, a Bluetooth protocol, a wireless local area network (WLAN) protocol, a cellular wide area network, and/or another wireless communication protocol. When the communication link 622 includes a wireless connection, messages and virtual GPIO signals may be encoded in packets, frames, subframes, or other structures that can be transmitted over the communication link 622, and the receiving peripheral device 624 may extract, deserialize and otherwise process received signaling to obtain the messages and virtual GPIO signals. Upon receipt of messages and/or virtual GPIO signals, the VGI FSM 626 or another component of the receiving device may interrupt its host processor to indicate receipt of messages and/or any changes in in GPIO signals.

In an example in which the communication link 622 is provided as a serial bus, messages and/or virtual GPIO signals may be transmitted in packets configured for an I2C, I3C, RFFE or another standardized serial interface. In the illustrated example, VGI techniques are employed to accommodate I/O bridging between an Application Processor 602 and a peripheral device 624. The Application Processor 602 may be implemented as an ASIC, SoC or some combination of devices. The Application Processor 602 includes a processor (central processing unit or CPU 604) that generates messages and GPIO associated with one or more communications channels 606. GPIO signals and messages produced by the communications channels 606 may be monitored by respective monitoring circuits 612, 614 in a VGI FSM 626. In some examples, a GPIO monitoring circuit 612 may be adapted to produce virtual GPIO signals representative of the state of physical GPIO signals and/or changes in the state of the physical GPIO signals. In some examples, other circuits are provided to produce the virtual GPIO signals representative of the state of physical GPIO signals and/or changes in the state of the physical GPIO signals.

An estimation circuit 618 may be configured to estimate latency information for the GPIO signals and messages, and may select a protocol, and/or a mode of communication for the communication link 622 that optimizes the latency for encoding and transmitting the GPIO signals and messages. The estimation circuit 618 may maintain protocol and mode information 616 that characterizes certain aspects of the communication link 622 to be considered when selecting the protocol, and/or a mode of communication. The estimation circuit 618 may be further configured to select a packet type for encoding and transmitting the GPIO signals and messages. The estimation circuit 618 may provide configuration information used by a packetizer 620 to encode the GPIO signals and messages. In one example, the configuration information is provided as a command that may be encapsulated in a packet such that the type of packet can be determined at a receiver. The configuration information, which may be a command, may also be provided to physical layer circuits (PHY 608). The PHY 608 may use the configuration information to select a protocol and/or mode of communication for transmitting the associated packet. The PHY 608 may then generate the appropriate signaling to transmit the packet.

The peripheral device 624 may include a VGI FSM 626 that may be configured to process data packets received from the communication link 622. The VGI FSM 626 at the peripheral device 624 may extract messages and may map bit positions in virtual GPIO signals onto physical GPIO pins in the peripheral device 624. In certain embodiments, the communication link 622 is bidirectional, and both the Application Processor 602 and a peripheral device 624 may operate as both transmitter and receiver.

The PHY 608 in the Application Processor 602 and a corresponding PHY 628 in the peripheral device 624 may be configured to establish and operate the communication link 622. The PHY 608 and 628 may be coupled to, or include a wireless transceiver 108 (see FIG. 1) that supports wireless communications. In some examples, the PHY 608 and 628 may support a two-wire interface such an I2C, I3C, RFFE or SMBus interface at the Application Processor 602 and peripheral device 624, respectively and virtual GPIO and messages may be encapsulated into a packet transmitted over the communication link 622, which may be a multi-wire serial bus.

VGI tunneling, according to certain aspects described herein, can be implemented using existing or available protocols configured for operating the communication link 622, and without the full complement of physical GPIO pins. VGI FSMs 610, 626 may handle GPIO signaling without intervention of a processor in the Application Processor 602 and/or in the peripheral device 624. The use of VGI can reduce pin count, power consumption, and latency associated with the communication link 622.

At the receiving device virtual GPIO signals are converted into physical GPIO signals. Certain characteristics of the physical GPIO pins may be configured using the virtual GPIO signals. For example, slew rate, polarity, drive strength, and other related parameters and attributes of the physical GPIO pins may be configured using the virtual GPIO signals. Configuration parameters used to configure the physical GPIO pins may be stored in configuration registers associated with corresponding GPIO pins. These configuration parameters can be addressed using a proprietary or conventional protocol such as I2C, I3C or RFFE. In one example, configuration parameters may be maintained in I3C addressable registers. Certain aspects disclosed herein relate to reducing latencies associated with the transmission of configuration parameters and corresponding addresses (e.g., addresses of registers used to store configuration parameters).

The VGI interface enables transmission of messages and virtual GPIO, whereby virtual GPIO, messages, or both can be sent in the serial data stream over a wired or wireless communication link 622. In one example, a serial data stream may be transmitted in packets and/or as a sequence of transactions over an I2C, I3C or RFFE bus. In some examples, the presence of virtual GPIO data in an I2C and/or I3C frame may be signaled using a special command code to identify the frame as a VGPIO frame. VGPIO frames may be transmitted as broadcast frames or addressed frames in accordance with an I2C or I3C protocol. In some implementations, a serial data stream may be transmitted in a form that resembles a universal asynchronous receiver/transmitter (UART) signaling protocol, in what may be referred to as VGI_UART mode of operation.

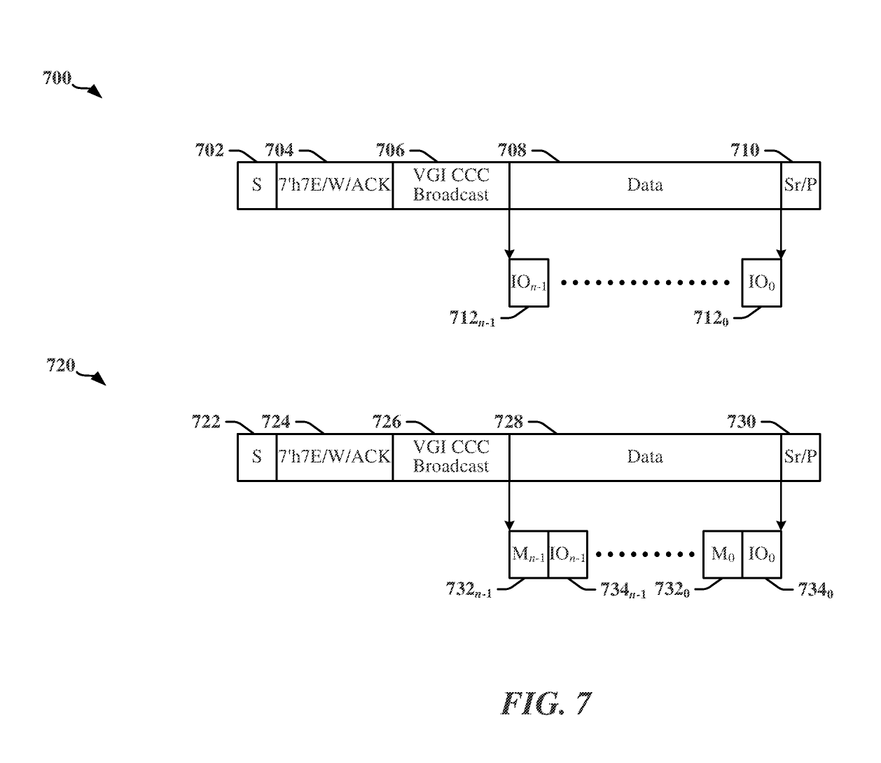

FIG. 7 illustrates certain examples of VGI broadcast frames 700, 720. In a first example, a broadcast frame 700 commences with a start bit 702 (S) followed by a header 704 in accordance with an I2C or I3C protocol. A VGI broadcast frame may be identified using a VGI broadcast common command code 706. A VGPIO data payload 708 includes a number (n) of virtual GPIO signals 712₀-712ₙ₋₁, ranging from a first virtual GPIO signal 712₀ to an nth virtual GPIO signal 712ₙ₋₁. A VGI FSM may include a mapping table that maps bit positions of virtual GPIO signals in a VGPIO data payload 708 to conventional GPIO pins. The virtual nature of the signaling in the VGPIO data payload 708 can be transparent to processors in the transmitting and receiving devices.

In the second example, a masked VGI broadcast frame 720 may be transmitted by a host device to change the state of one or more GPIO pins without disturbing the state of other GPIO pins. In this example, the I/O signals for one or more devices are masked, while the I/O signals in a targeted device are unmasked. The masked VGI broadcast frame 720 commences with a start bit 722 followed by a header 724. A masked VGI broadcast frame 720 may be identified using a masked VGI broadcast common command code 726. The VGPIO data payload 728 may include I/O signal values 734₀-734ₙ₋₁ and corresponding mask bits 732₀-732ₙ₋₁, ranging from a first mask bit M₀ 732₀ for the first I/O signal (IO₀) to an nth mask bit Mₙ₋₁₇32ₙ₋₁ for the nth I/O signal IOₙ₋₁.

A stop bit or synchronization bit (Sr/P 710, 730) terminates the broadcast frame 700, 720. A synchronization bit may be transmitted to indicate that an additional VGPIO payload is to be transmitted. In one example, the synchronization bit may be a repeated start bit in an I2C interface.

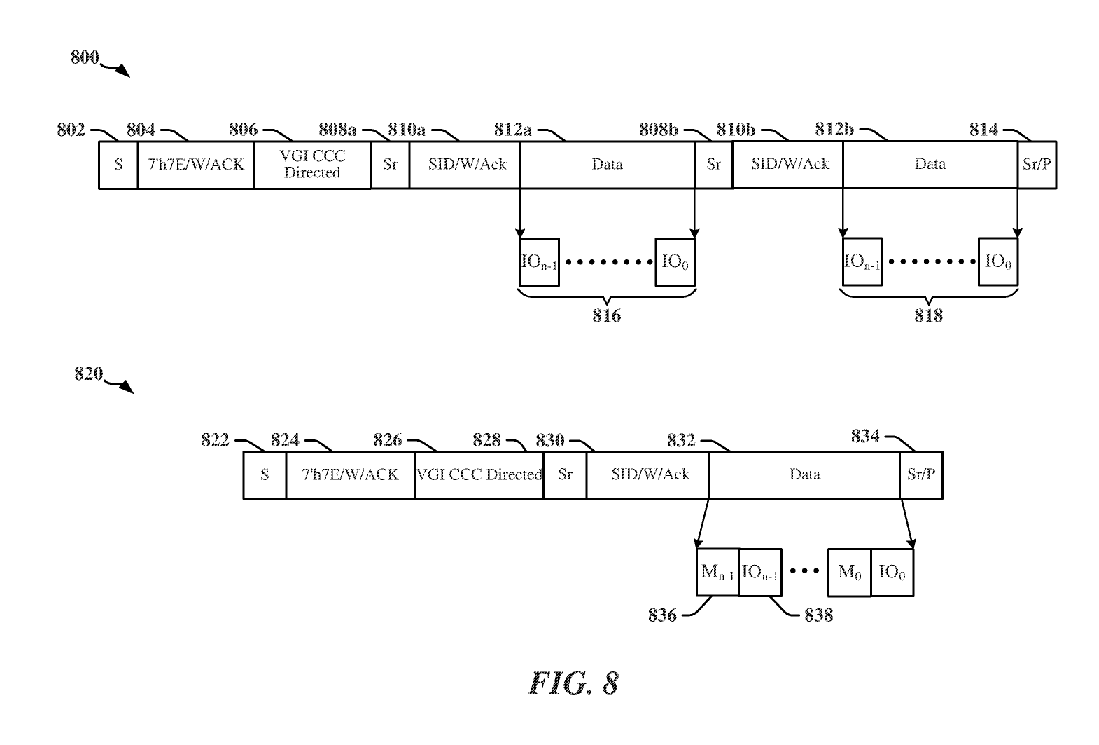

FIG. 8 illustrates certain examples of VGI directed frames 800, 820. In a first example, VGI directed frames 800 may be addressed to a single peripheral device or, in some instances, to a group of peripheral devices. The first of the VGI directed frames 800 commences with a start bit 802 (S) followed by a header 804 in accordance with an I2C or I3C protocol. A VGI directed frame 800 may be identified using a VGI directed common command code 806. The directed common command code 806 may be followed by a synchronization field 808a (Sr) and an address field 810a that includes a slave identifier to select the addressed device. The directed VGPIO data payload 812a that follows the address field 810a includes values 816 for a set of I/O signals that pertain to the addressed device. VGI directed frames 800 can include additional directed payloads 812b for additional devices. For example, the first directed VGPIO data payload 812a may be followed by a synchronization field 808b and a second address field 810b. In this example, the second directed VGPIO payload 812b includes values 818 for a set of I/O signals that pertain to a second addressed device. The use of VGI directed frames 800 may permit transmission of values for a subset or portion of the I/O signals carried in a broadcast VGPIO frame 700, 720.

In the second example, a masked VGI directed frame 820 may be transmitted by a host device to change the state of one or more GPIO pins without disturbing the state of other GPIO pins in a single peripheral device and without affecting other peripheral devices. In some examples, the I/O signals in one or more devices may be masked, while selected I/O signals in one or more targeted device are unmasked. The masked VGI directed frame 820 commences with a start bit 822 followed by a header 824. A masked VGI directed frame 820 may be identified using a masked VGI directed common command code 826. The masked VGI directed command code 826 may be followed by a synchronization field 828 (Sr) and an address field 830 that includes a slave identifier to select the addressed device. The directed payload 832 that follows includes VGPIO values for a set of I/O signals that pertain to the addressed device. For example, the VGPIO values in the directed data payload 832 may include I/O signal values 838 and corresponding mask bits 836.

A stop bit or synchronization bit (Sr/P 814, 834) terminates the VGI directed frames 800, 820. A synchronization bit may be transmitted to indicate that an additional VGPIO payload is to be transmitted. In one example, the synchronization bit may be a repeated start bit in an I2C interface.

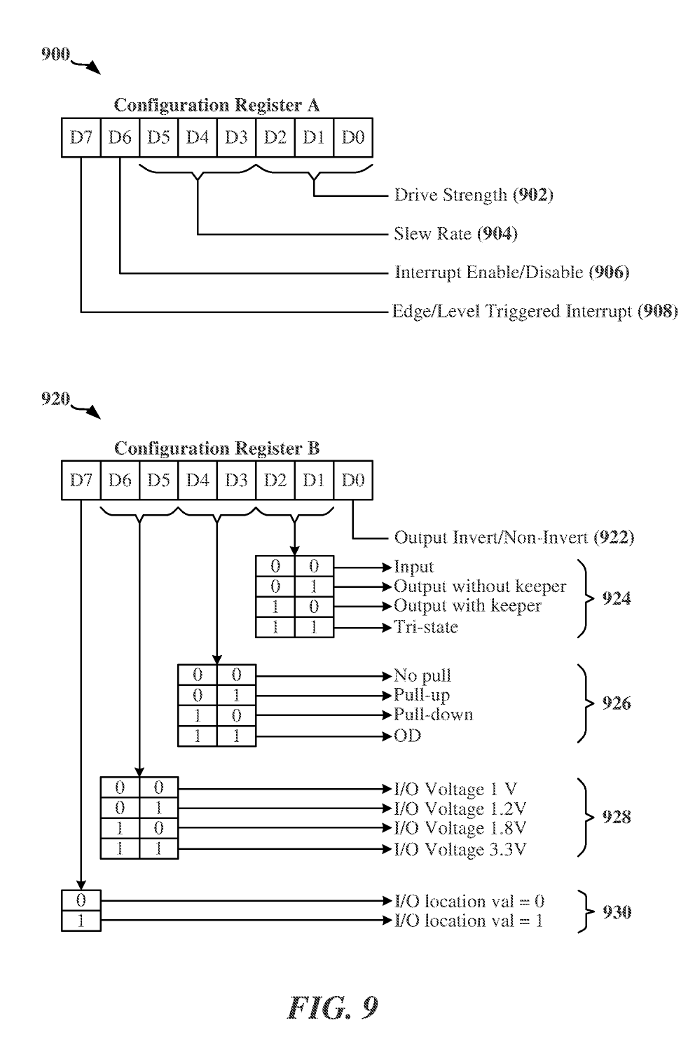

At the receiving device (e.g., the Application Processor 502 and/or peripheral device 504, 506, 508), received virtual GPIO signals are expanded into physical GPIO signal states presented on GPIO pins. The term “pin,” as used herein, may refer to a physical structure such as a pad, pin or other interconnecting element used to couple an IC to a wire, trace, through-hole via, or other suitable physical connector provided on a circuit board, substrate or the like. Each GPIO pin may be associated with one or more configuration registers that store configuration parameters for the GPIO pin. FIG. 9 illustrates configuration registers 900 and 920 that may be associated with a physical pin. Each configuration register 900, 920 is implemented as a one-byte (8 bits) register, where different bits or groups of bits define a characteristic or other features that can be controlled through configuration. In a first example, bits D0-D2 902 control the drive strength for the GPIO pin, bits D3-D5 904 control the slew rate for GPIO pin, bit D6 906 enables interrupts, and bit D7 908 determines whether interrupts are edge-triggered or triggered by voltage-level. In a second example, bit D0 922 selects whether the GPIO pin receives an inverted or non-inverted signal, bits D1-D2 924 define a type of input or output pin, bits D3-D4 926 defines certain characteristics of an undriven pin, bits D5-D6 928 define voltage levels for signaling states, and bit D7 930 controls the binary value for the GPIO pin (i.e., whether GPIO pin carries carry a binary one or zero).

### Example of a Virtual GPIO Finite State Machine

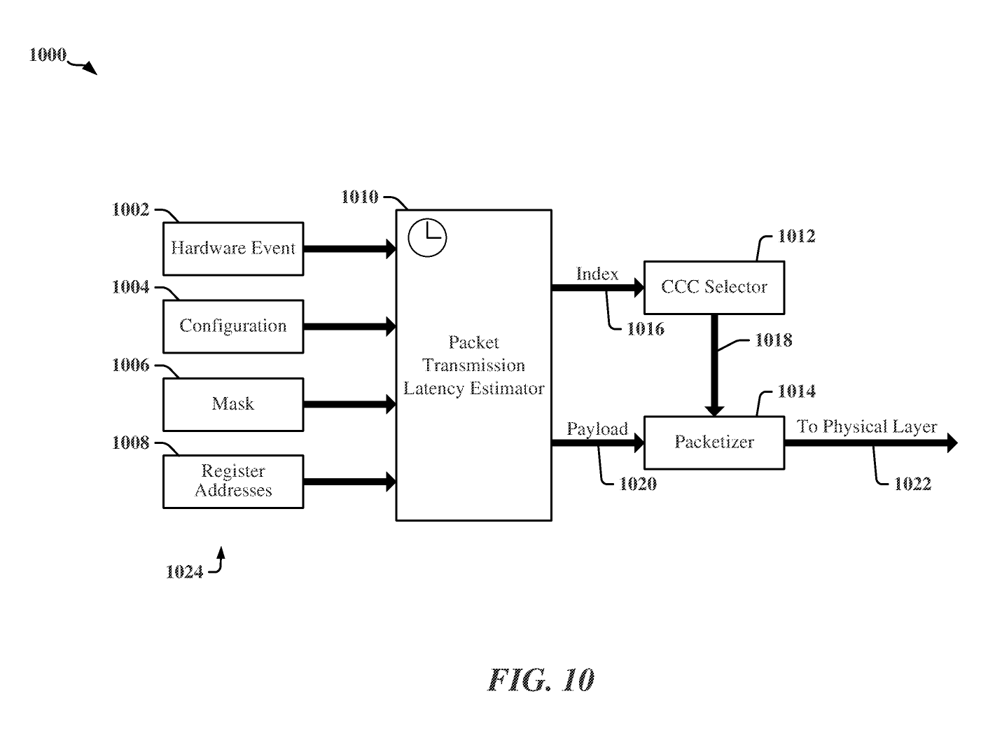

FIG. 10 illustrates certain aspects of a finite state machine 1000 that can support virtual GPIO in an apparatus. The finite state machine 1000 may monitor state information from a plurality of input sources 1024, including hardware events 1002, configuration parameters 1004, masked data 1006 and/or configuration parameter register addresses 1008. The finite state machine 1000 may select a protocol to be used for generating packets to be transmitted over a physical link. The finite state machine 1000 may implement the VGI FSM 406, 416 provided in the host SoC 402 and/or in one or more peripheral devices 412, as illustrated in FIG. 4. In various examples, the finite state machine 1000 may be provided in a very low latency domain, where signaling, switching, buffering and other delays can be minimized.

The finite state machine 1000 may be deployed in an always-on domain to ensure that circuits configured to monitor state and state changes are available when certain input/output states are of interest, including when an active peripheral device is associated with the input/output states of interest. In many implementations, it may be necessary to provide the finite state machine 1000 in the always-on domain to permit reliable monitoring of input/output state.

In some implementations, the finite state machine 1000 may be deployable in a domain that is active when states monitored by the finite state machine 1000 are being modified, where the domain may also be inactive on occasion. In instances where the finite state machine 1000 is deployed in a domain that is not an always-on domain, low latency wakeup techniques and procedures may be employed to cause the finite state machine 1000 to enter an active state within tolerable latencies. In one example, a different finite state machine located in an always-on domain can monitor input state, output state and other operational states in order to initiate timely wakeup of the finite state machine 1000 that supports virtual GPIO. In another example, a processor may be used to initiate wakeup of the finite state machine 1000 that supports virtual GPIO. In another example, some combination of a different finite state machine and a processor may be used to initiate wakeup of the finite state machine 1000 that supports virtual GPIO.

The finite state machine 1000 may be configured to transmit several different types of packets, and the finite state machine 1000 may select a type of packet in order to optimize latency in the communication link In one example, the finite state machine 1000 may select the packet type based on the GPIO data to be transmitted and an associated configuration of GPIO pins. A packet transmission latency estimator 1010 may monitor hardware events 1002 in order to estimate latency associated with transmitting GPIO states or state changes arising from one or more hardware events 1002. The packet transmission latency estimator 1010 may determine whether masked data 1006 are to be used, GPIO configuration parameters 1004, and configuration parameter register addresses 1008. The packet transmission latency estimator 1010 may produce estimates that are based on the frequency at which GPIO pins are configured. In one example where GPIO pins are infrequently configured, the packet transmission latency estimator 1010 may configure pins using traditional addressed I2C/I3C packets with increased latency. In another example, virtualized GPIO signals and messaging signals may be transmitted without register addresses and a finite state machine at the receiver may determine identity of the GPIO signals and messages based on bit position within a corresponding frame or packet. In the latter example, latency may be reduced by virtualizing configuration data along with the GPIO data when the GPIO pins are frequently re-configured. The packet transmission latency estimator 1010 may estimate latencies using a packet-specific latency estimator configured for each packet type. A comparator may be employed to determine the minimum latency estimated by packet-specific latency estimators configured for the different packet types. The output of the comparator may determine the packet type to be selected for transmission, and/or on other parameters considered by the packet transmission latency estimator 1010.

The packet transmission latency estimator 1010 may provide information used to select a command code 1018 that determines the type of packet to be used in transmission. For example, the packet transmission latency estimator 1010 may provide an index 1016 to a command code selector module 1012, which uses the index 1016 to select from a plurality of possible command codes. A packetizer block 1014 may serialize data in the payload 1020 (e.g., information related to hardware events 1002) and/or configuration parameters 1004 in accordance with the selected command code 1018. The resulting packet 1022 may be provided to the physical layer (PHY) for transmission by the corresponding I2C/I3C interface.

GPIO states may be sent using either a GPIO-state-only packet such as a masked packet or an unmasked packet. In one example, GPIO-state-only packet type may be selected when GPIO pins are configured infrequently. A GPIO-state-only packet may be identified by a receiver based on the command code header transmitted in the packet. In some instances, merged or combined packets may be transmitted. Merged or combined packets may combine both GPIO state information and configuration data associated with GPIO pins. At the receiver, an I/O mapping table may be implemented or maintained to map bit positions of a merged packet to a host I/O number, a peripheral device number, peripheral address, and peripheral I/O parameter. For example, a first mask bit and a corresponding value in a merged packet may be mapped to a peripheral address (e.g., 0x01) in a first peripheral device. For this bit position, the corresponding bit may be a GPIO state for the identified GPIO pin. The second mask bit, which follows the first mask bit, and a corresponding bit in the merged packet may be associated with a selection of drive strength for the same identified GPIO pin. A merged packet may include, in various proportions, GPIO states and configuration parameters as required to optimize the transmission latency.

### Virtual GPIO in a Multi-Protocol Interface

Certain interfaces can be switched between modes of communication distinguished by signaling. For example, an I3C bus can be operated in an I2C compatibility mode of operation in which I2C protocols may be used on the bus, particularly for communicating with legacy I2C devices. An I3C interface may be configured for multiple modes of communication that have different attributes, including data transfer rates and power consumption attributes. In one example, the I3C bus may be operated in a first mode in which a clock signal is transmitted on a clock wire 420 and data is transmitted on a data wire 418 (see FIG. 4) and, in a second mode, data may be encoded in symbols that represent the signaling state of the clock wire 420 and the data wire 418 in each symbol transmission interval.

In conventional systems, the characteristics and attributes of different protocols are firm in the sense that the structure of a protocol cannot be changed to achieve an optimal transmission latency for the different types or sources of information to be transmitted. A finite state machine provided in accordance with certain aspects disclosed herein may be adapted to achieve optimal latency through selection of protocol scheme as well as packet type. The adapted finite state machine may be well-suited to meeting transmission deadlines in real-time embedded system applications, where meeting transmission deadlines is of paramount importance.

The finite state machine 1000 of FIG. 10 may be adapted to select between protocols used to transmit GPIO state and messages. Parameters to be serially transmitted are taken as inputs and the packet transmission latency estimator 1010 may be configured to optimize latency by determining the optimal protocol to be used for each information (I/O and messaging) transfer. A unique command code selected from a pool of pre-defined and mutually agreed upon command codes may be used to inform the receiver of the protocol to be used to receive the packets carrying the GPIO state and messages. The command codes may be proprietary command codes or may be defined by protocol, standards and/or may be defined based on application-specific considerations. In one example, the command codes may include certain common command codes (CCCs) defined the MIPI Alliance.

The command code may be selected using the index 1016 generated by the packet transmission latency estimator 1010. The selected command code 1018 is provided to the packetizer block 1014 along with the payload 1020. The packetizer block 1014 creates a packet 1022 and the control information necessary to cause the physical layer to transmit the packet 1022 in accordance with the selected protocol scheme. The packetizer block 1014 passes the packet 1022 and the control information to the physical layer. In one example, an I3C physical layer may support I3C modes of communication involving multiple different I3C protocols and/or one or more I2C protocols or configurations. In another example, an RFFE physical layer may support different signaling schemes and/or protocols.

In the example depicted in FIG. 10, the input sources 1024 may be prioritized. In one example, state changes resulting from hardware events 1002 may have highest priority, followed by GPIO configuration parameters 1004, followed by masked data 1006, which is followed by interactions with specified register addresses 1008. The packet transmission latency estimator 1010 may determine the best available protocol for transmitting each payload 1020 generated from the input sources 1024. The packet transmission latency estimator 1010 may base the determination of best available protocol on data rate and latency attributes of each protocol. For example, the packet transmission latency estimator 1010 may evaluate worst case latency based on the time required to configure the serial bus for each protocol, delays in initiating transmission, and/or time required to transmit the payload 1020. In some instances, the line turnaround time may be taken into consideration when read and write transactions are to be performed sequentially. In other examples, the packet transmission latency estimator 1010 may be configured to determine protocol schemes based on power consumption, power budgets, and priorities configured by an application.

The finite state machine 1000 may operate independently of applications, and/or the physical layer used to communicate between devices. The finite state machine 1000 may operate when an Application Processor 502 (see FIG. 5) and/or one or more peripheral devices 504, 506, 508 are in a stand-by or sleep mode. In the latter case, the finite state machine 1000 may maintain consistency of GPIO states when the Application Processor 502 or peripheral device 504, 506, 508 is in sleep mode when another device causes a change in GPIO state. In some examples, the finite state machine 1000 may be configured by an application. In some implementations, certain functions of the finite state machine 1000 may be performed using software modules including, for example, in implementations that are subject to system-wide prioritization of resource and/or power usage.

In some instances, a finite state machine 1000 may optimize latency by selecting between different physical layers. For example, the finite state machine 1000 may select between a first physical layer that supports an RFFE communication link between two devices and a second physical layer that supports an I2C or I3C communication link between the two devices.

According to certain aspects, a finite state machine 1000 may reformat messaging packets to obtain a format of packet that optimizes latency for a selected protocol. The finite state machine 1000 may optimize latency by selecting a packet best suited to enable transfer of the messaging and/or GPIO state content with optimal and/or minimized latency.

### Examples of Processing Circuits and Methods

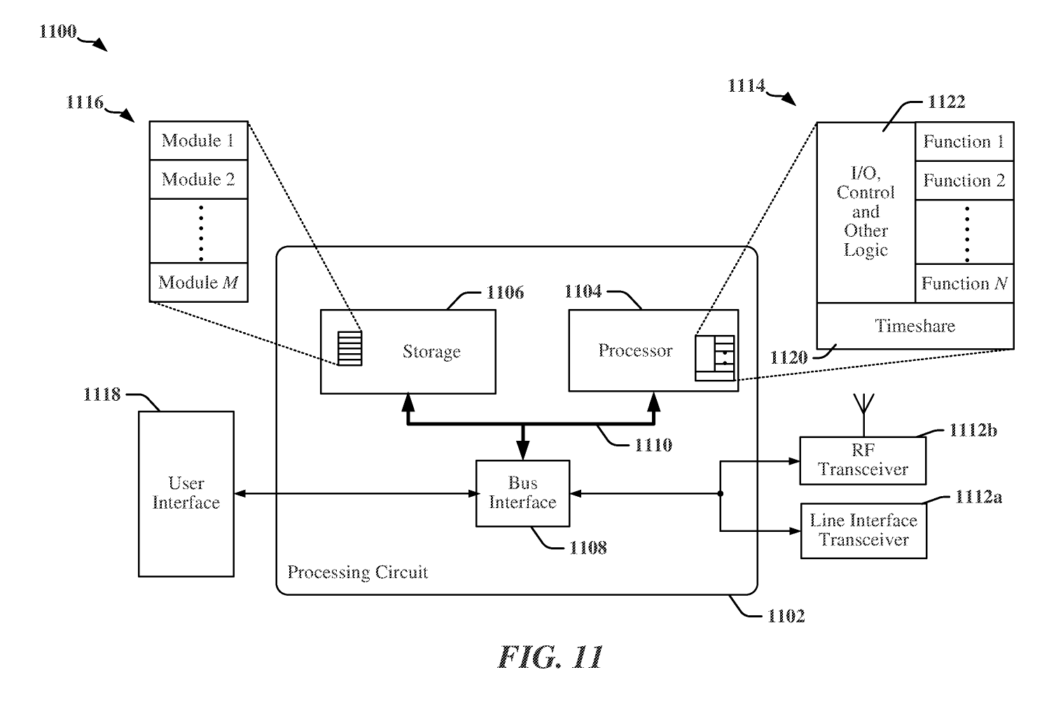

FIG. 11 is a diagram illustrating an example of a hardware implementation for an apparatus 1100 employing a finite state machine 610, 1000 to optimize virtual GPIO latency. In some examples, the apparatus 1100 may configure the operation of the finite state machine 610, 1000. In some examples, the apparatus 1100 may perform one or more functions disclosed herein. In accordance with various aspects of the disclosure, an element, or any portion of an element, or any combination of elements as disclosed herein may be implemented using a processing circuit 1102. The processing circuit 1102 may include one or more processors 1104 that are controlled by some combination of hardware and software modules. Examples of processors 1104 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 1104 may include specialized processors that perform specific functions, and that may be configured, augmented or controlled by one of the software modules 1116. The one or more processors 1104 may be configured through a combination of software modules 1116 loaded during initialization, and further configured by loading or unloading one or more software modules 1116 during operation.

In the illustrated example, the processing circuit 1102 may be implemented with a bus architecture, represented generally by the bus 1110. The bus 1110 may include any number of interconnecting buses and bridges depending on the specific application of the processing circuit 1102 and the overall design constraints. The bus 1110 links together various circuits including the one or more processors 1104, and storage 1106. Storage 1106 may include memory devices and mass storage devices, and may be referred to herein as computer-readable media and/or processor-readable media. The bus 1110 may also link various other circuits such as timing sources, timers, peripherals, voltage regulators, and power management circuits. A bus interface 1108 may provide an interface between the bus 1110 and one or more transceivers 1112a, 1112b. A transceiver 1112a, 1112b may be provided for each networking technology supported by the processing circuit. In some instances, multiple networking technologies may share some or all of the circuitry or processing modules found in a transceiver 1112a, 1112b. Each transceiver 1112a, 1112b provides a means for communicating with various other apparatus over a transmission medium. In one example, a transceiver 1112a may be used to couple the apparatus 1100 to a multi-wire bus. In another example, a transceiver 1112b may be used to connect the apparatus 1100 to a wireless network. Depending upon the nature of the apparatus 1100, a user interface 1118 (e.g., keypad, display, speaker, microphone, joystick) may also be provided, and may be communicatively coupled to the bus 1110 directly or through the bus interface 1108.

A processor 1104 may be responsible for managing the bus 1110 and for general processing that may include the execution of software stored in a computer-readable medium that may include the storage 1106. In this respect, the processing circuit 1102, including the processor 1104, may be used to implement any of the methods, functions and techniques disclosed herein. The storage 1106 may be used for storing data that is manipulated by the processor 1104 when executing software, and the software may be configured to implement any one of the methods disclosed herein.

One or more processors 1104 in the processing circuit 1102 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1106 or in an external computer-readable medium. The external computer-readable medium and/or storage 1106 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 1106 may also include, by way of example, a carrier wave, a transmission line, and any other suitable medium for transmitting software and/or instructions that may be accessed and read by a computer. Computer-readable medium and/or the storage 1106 may reside in the processing circuit 1102, in the processor 1104, external to the processing circuit 1102, or be distributed across multiple entities including the processing circuit 1102. The computer-readable medium and/or storage 1106 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1106 may maintain software maintained and/or organized in loadable code segments, modules, applications, programs, etc., which may be referred to herein as software modules 1116. Each of the software modules 1116 may include instructions and data that, when installed or loaded on the processing circuit 1102 and executed by the one or more processors 1104, contribute to a run-time image 1114 that controls the operation of the one or more processors 1104. When executed, certain instructions may cause the processing circuit 1102 to perform functions in accordance with certain methods, algorithms and processes described herein.

Some of the software modules 1116 may be loaded during initialization of the processing circuit 1102, and these software modules 1116 may configure the processing circuit 1102 to enable performance of the various functions disclosed herein. For example, some software modules 1116 may configure internal devices and/or logic circuits 1122 of the processor 1104, and may manage access to external devices such as the transceiver 1112, the bus interface 1108, the user interface 1118, timers, mathematical coprocessors, and so on. The software modules 1116 may include a control program and/or an operating system that interacts with interrupt handlers and device drivers, and that controls access to various resources provided by the processing circuit 1102. The resources may include memory, processing time, access to the transceiver 1112, the user interface 1118, and so on.

One or more processors 1104 of the processing circuit 1102 may be multifunctional, whereby some of the software modules 1116 are loaded and configured to perform different functions or different instances of the same function. The one or more processors 1104 may additionally be adapted to manage background tasks initiated in response to inputs from the user interface 1118, the transceiver 1112, and device drivers, for example. To support the performance of multiple functions, the one or more processors 1104 may be configured to provide a multitasking environment, whereby each of a plurality of functions is implemented as a set of tasks serviced by the one or more processors 1104 as needed or desired. In one example, the multitasking environment may be implemented using a timesharing program 1120 that passes control of a processor 1104 between different tasks, whereby each task returns control of the one or more processors 1104 to the timesharing program 1120 upon completion of any outstanding operations and/or in response to an input such as an interrupt. When a task has control of the one or more processors 1104, the processing circuit is effectively specialized for the purposes addressed by the function associated with the controlling task. The timesharing program 1120 may include an operating system, a main loop that transfers control on a round-robin basis, a function that allocates control of the one or more processors 1104 in accordance with a prioritization of the functions, and/or an interrupt driven main loop that responds to external events by providing control of the one or more processors 1104 to a handling function.

Methods for optimizing virtual GPIO latency may include an act of parsing various input sources including sources of GPIO signal state, parameters and/or messages to be transmitted. The input sources may include hardware events, configuration data, mask parameters, and register addresses. Packet-specific latency estimators may be employed to estimate the latency for corresponding packet types based upon the parsed parameters. A packet type to be used for transmission may be selected based on the minimum latency calculated or determined for available packet types. The selected packet type may be identified using a command code, which may be provided to a packetizer with a payload to be transmitted. The command code may also reflect a protocol to be used to transmit the payload. In some implementations, the physical link used to transmit the payload may be operated according to different protocols or different variants of one or more protocols. The protocol to be used for transmitting the payload may be selected based on latencies associated with the various available protocols or variants of protocols.

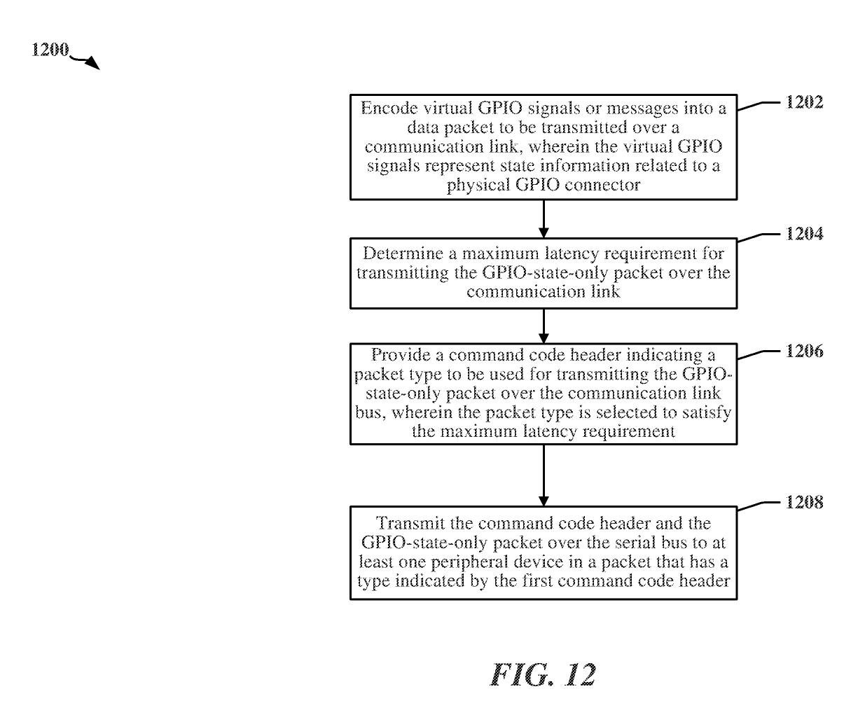

FIG. 12 is a flowchart 1200 of a method that may be performed at a transmitting device. Portions of the method may be performed by a finite state machine in the transmitting device.

At block 1202, the finite state machine may encode virtual GPIO signals or messages into a data packet to be transmitted over a communication link. The virtual GPIO signals may represent state information related to a physical GPIO connector.

At block 1204, the finite state machine may determine a maximum latency requirement for transmitting the data packet over the communication link.

At block 1206, the finite state machine may provide a command code header indicating a packet type to be used for transmitting the data packet over the communication link. The packet type may be selected to satisfy the maximum latency requirement.

At block 1208, the finite state machine may transmit the command code header and the data packet over the communication link to at least one peripheral device in a packet that has a type indicated by the command code header.

In some examples, the finite state machine may determine a mode of operation for the serial bus to be used when transmitting the data packet based on the maximum latency requirement and one or more attributes of a plurality of modes of operation associated with the serial bus. The finite state machine may configure the command code header to indicate the mode of operation to a physical layer circuit to be used for transmitting the data packet.

In some examples, the communication link includes a serial bus. The finite state machine may determine a protocol to be used for transmitting the data packet based on the maximum latency requirement and one or more attributes of a plurality of protocols available for use on the serial bus. The finite state machine may configure the command code header to indicate the protocol to be used for transmitting the data packet. The plurality of protocols available for use on the serial bus may include an I2C protocol, an I3C protocol, or an RFFE protocol.

In some examples, the communication link includes a wireless communication link. The finite state machine may determine a protocol to be used for transmitting the data packet based on the maximum latency requirement and one or more attributes of a plurality of protocols available for use on the wireless communication link. The finite state machine may configure the command code header to indicate the protocol to be used for transmitting the data packet. The plurality of protocols may include a Bluetooth protocol, a protocol associated with a wireless local area network, or a protocol associated with a cellular wireless network.

In some examples, the data packet includes virtual GPIO signals corresponding to configuration parameters for GPIO pins in the at least one peripheral device. The configuration parameters may include slew rate parameters or drive strength parameters.

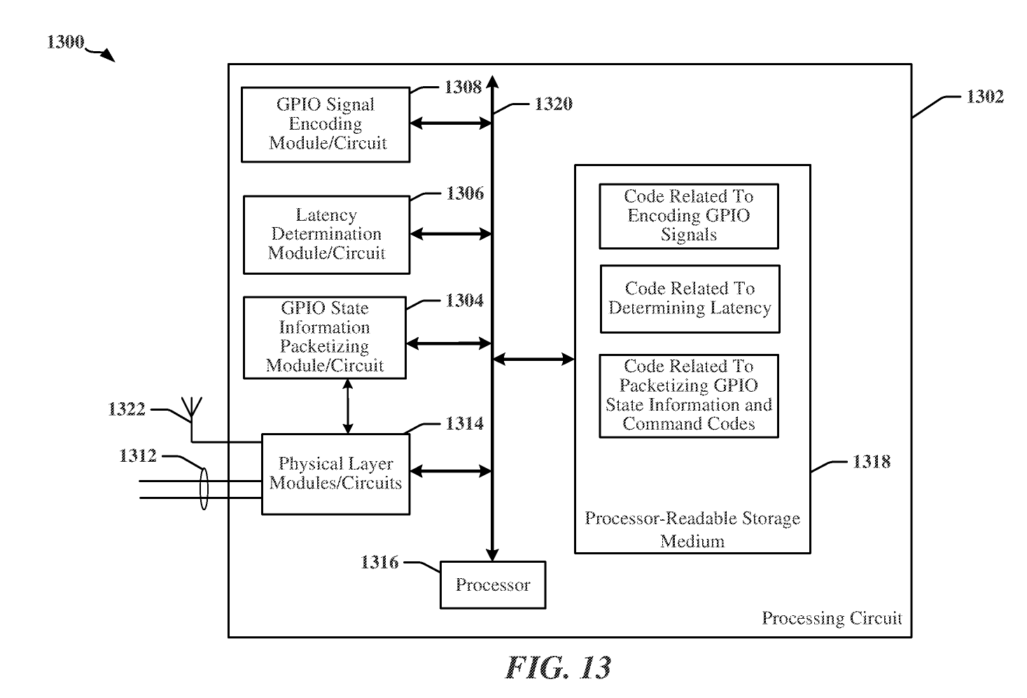

FIG. 13 is a diagram illustrating a simplified example of a hardware implementation for an apparatus 1300 employing a processing circuit 1302. The apparatus may implement a bridging circuit in accordance with certain aspects disclosed herein. The processing circuit typically has a controller or processor 1316 that may include one or more microprocessors, microcontrollers, digital signal processors, sequencers and/or state machines. The processing circuit 1302 may be implemented with a bus architecture, represented generally by the bus 1320. The bus 1320 may include any number of interconnecting buses and bridges depending on the specific application of the processing circuit 1302 and the overall design constraints. The bus 1320 links together various circuits including one or more processors and/or hardware modules, represented by the controller or processor 1316, the modules or circuits 1304, 1306 and 1308, and the processor-readable storage medium 1318. One or more physical layer circuits and/or modules 1314 may be provided to support communications over a communication link implemented using a multi-wire bus 1312, through an antenna 1322 (to a wireless network for example), and so on. The bus 1320 may also link various other circuits such as timing sources, peripherals, voltage regulators, and power management circuits, which are well known in the art, and therefore, will not be described any further.

The processor 1316 is responsible for general processing, including the execution of software, code and/or instructions stored on the processor-readable storage medium 1318. The processor-readable storage medium may include a non-transitory storage medium. The software, when executed by the processor 1316, causes the processing circuit 1302 to perform the various functions described supra for any particular apparatus. The processor-readable storage medium may be used for storing data that is manipulated by the processor 1316 when executing software. The processing circuit 1302 further includes at least one of the modules 1304, 1306 and 1308. The modules 1304, 1306 and 1308 may be software modules running in the processor 1316, resident/stored in the processor-readable storage medium 1318, one or more hardware modules coupled to the processor 1316, or some combination thereof. The modules 1304, 1306 and 1308 may include microcontroller instructions, state machine configuration parameters, or some combination thereof.

In one configuration, the apparatus 1300 includes modules and/or circuits 1308 configured to serialize GPIO signals into a GPIO-state-only information, modules and/or circuits 1306 configured to determine a maximum latency requirement for transmitting the GPIO-state-only information over a communication link, and modules and/or circuits 1304 configured to provide a packet comprising the GPIO-state-only information and a command code to a physical layer circuit 1314. In one example, the command code indicates a packet type to be used for transmitting the GPIO-state-only information over the serial bus. The packet type may be selected to satisfy the maximum latency requirement. In another example, the command code indicates a protocol to be used for transmitting the GPIO-state-only information. The protocol may be selected based on the maximum latency requirement and one or more attributes of a plurality of protocols available for use on the communication link.

In various examples, the apparatus 1300 includes one or more physical layer circuits and/or modules 1314, which may correspond to the PHY 608 of FIG. 6 and which may be adapted to couple the apparatus to a communication link, a packetizer 620 or packetizer block 1014 configured to encode messages or virtual GPIO signals in a data packet to be transmitted over the communication link, and a finite state machine 610 or 1000 configured to determine a maximum latency requirement for transmitting the data packet over the communication link, and provide a command code to the packetizer, the command code indicating a packet type to be used for transmitting the data packet over the communication link. The packet type may be selected to satisfy the maximum latency requirement. The packetizer may be configured to provide a packet comprising the data packet and the command code to the PHY 608. The PHY 608 may be configured to transmit the packet over the communication link to at least one peripheral device 412, 504, 506, 508 or 624.

In one example, the communication link includes a multi-wire bus 1312 configured to operate as a serial bus. The finite state machine 610 or 1000 may be configured to determine a protocol to be used for transmitting the data packet based on the maximum latency requirement and one or more attributes of a plurality of protocols available for use on the serial bus, and configure the command code to indicate the protocol to be used for transmitting the packet. The plurality of protocols may include an I2C protocol, an I3C protocol or an RFFE protocol.

In another example, the finite state machine 610 or 1000 may be configured to determine a mode of operation for the communication link to be used when transmitting the data packet based on the maximum latency requirement and one or more attributes of a plurality of modes of operation associated with the communication link, and configure the first command code header to indicate the mode of operation to be used for transmitting the data packet to the PHY 608.

In another example, the communication link includes a wireless communication link accessible, for example, through an antenna 124 or 1322. The finite state machine 610 or 1000 may be configured to determine a protocol to be used for transmitting the data packet based on the maximum latency requirement and one or more attributes of a plurality of protocols available for use on the wireless communication link, and configure the first command code header to indicate the protocol to be used for transmitting the data packet. The plurality of protocols may include a Bluetooth protocol, a protocol associated with a wireless local area network, or a protocol associated with a cellular wireless network.

In some examples, the data packet includes virtual GPIO signals corresponding to configuration parameters for GPIO pins in the at least one peripheral device 412, 504, 506, 508 or 624. The configuration parameters may include slew rate parameters or drive strength parameters.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

1. A method performed at a transmitting device, comprising:
encoding virtual general purpose input/output (GPIO) signals or messages into a data packet to be transmitted over a communication link, wherein the virtual GPIO signals represent state information related to a physical GPIO connector;
determining a maximum latency requirement for transmitting the data packet over the communication link;
providing a command code header indicating a packet type to be used for transmitting the data packet over the communication link, wherein the packet type is selected to satisfy the maximum latency requirement; and
transmitting the command code header and the data packet over the communication link to at least one peripheral device in a packet that has a type indicated by the command code header.

2. The method of claim 1, wherein the communication link includes a serial bus, and further comprising:
determining a protocol to be used for transmitting the data packet based on the maximum latency requirement and one or more attributes of a plurality of protocols available for use on the serial bus; and
configuring the command code header to indicate the protocol to be used for transmitting the data packet.

3. The method of claim 2, wherein the plurality of protocols available for use on the serial bus includes an I2C protocol.

4. The method of claim 2, wherein the plurality of protocols available for use on the serial bus includes an I3C protocol.

5. The method of claim 2, wherein the plurality of protocols available for use on the serial bus includes a radio frequency front-end (RFFE) protocol.

6. The method of claim 1, and further comprising:
determining a mode of operation for the communication link to be used when transmitting the data packet based on the maximum latency requirement and one or more attributes of a plurality of modes of operation associated with the communication link; and
configuring the command code header to indicate the mode of operation to a physical layer circuit to be used for transmitting the data packet.

7. The method of claim 1, wherein the communication link includes a wireless communication link, and further comprising:
determining a protocol to be used for transmitting the data packet based on the maximum latency requirement and one or more attributes of a plurality of protocols available for use on the wireless communication link; and
configuring the command code header to indicate the protocol to be used for transmitting the data packet.

8. The method of claim 7, wherein the plurality of protocols includes a Bluetooth protocol.

9. The method of claim 7, wherein the plurality of protocols includes a protocol associated with a wireless local area network.

10. The method of claim 7, wherein the plurality of protocols includes a protocol associated with a cellular wireless network.

11. The method of claim 1, wherein the data packet includes virtual GPIO signals corresponding to configuration parameters for GPIO pins in the at least one peripheral device.

12. The method of claim 11, wherein the configuration parameters include slew rate parameters.

13. The method of claim 11, wherein the configuration parameters include drive strength parameters.

14. An apparatus, comprising:
a physical layer circuit adapted to couple the apparatus to a communication link;
a packetizer configured to encode messages or virtual GPIO signals in a data packet to be transmitted over the communication link; and
a finite state machine configured to:
determine a maximum latency requirement for transmitting the data packet over the communication link; and
provide a command code to the packetizer, the command code indicating a packet type to be used for transmitting the data packet over the communication link, wherein the packet type is selected to satisfy the maximum latency requirement,
wherein the packetizer is configured to provide a packet comprising the data packet and the command code to the physical layer circuit, and
wherein the physical layer circuit is configured to transmit the packet over the communication link to at least one peripheral device.

15. The apparatus of claim 14, wherein the communication link includes a serial bus, and wherein the finite state machine is configured to:
determine a protocol to be used for transmitting the data packet based on the maximum latency requirement and one or more attributes of a plurality of protocols available for use on the serial bus; and
configure the command code to indicate the protocol to be used for transmitting the packet.

16. The apparatus of claim 15, wherein the plurality of protocols includes an I2C protocol, an I3C protocol or a radio frequency front-end (RFFE) protocol.

17. The apparatus of claim 14, wherein the finite state machine is configured to:
determine a mode of operation for the communication link to be used when transmitting the data packet based on the maximum latency requirement and one or more attributes of a plurality of modes of operation associated with the communication link; and
configure the command code to indicate the mode of operation to be used for transmitting the data packet to the physical layer circuit.

18. The apparatus of claim 14, wherein the communication link includes a wireless communication link, wherein the finite state machine is configured to:
determine a protocol to be used for transmitting the data packet based on the maximum latency requirement and one or more attributes of a plurality of protocols available for use on the wireless communication link; and
configure the command code to indicate the protocol to be used for transmitting the data packet.

19. The apparatus of claim 18, wherein the plurality of protocols includes a Bluetooth protocol, a protocol associated with a wireless local area network, or a protocol associated with a cellular wireless network.

20. The apparatus of claim 14, wherein the data packet includes virtual GPIO signals corresponding to configuration parameters for GPIO pins in the at least one peripheral device.

21. The apparatus of claim 20, wherein the configuration parameters include slew rate parameters.

22. The apparatus of claim 20, wherein the configuration parameters include drive strength parameters.

23. An apparatus, comprising:
means for encoding virtual general purpose input/output (GPIO) signals or messages into a data packet to be transmitted over a communication link, wherein the virtual GPIO signals represent state information related to a physical GPIO connector;
means for determining a maximum latency requirement for transmitting the data packet over the communication link;
means for providing a command code header indicating a packet type to be used for transmitting the data packet over the communication link, wherein the packet type is selected to satisfy the maximum latency requirement; and
means for transmitting the command code header and the data packet over the communication link to at least one peripheral device in a packet that has a type indicated by the command code header.

24. The apparatus of claim 23, wherein the communication link includes a serial bus, and wherein the means for determining a maximum latency requirement is configured to:
determine a protocol to be used for transmitting the data packet based on the maximum latency requirement and one or more attributes of a plurality of protocols available for use on the serial bus; and
configure the command code header to indicate the protocol to be used for transmitting the data packet,
wherein the plurality of protocols available for use on the serial bus includes an I2C protocol, an I3C protocol or a radio frequency front-end protocol.

25. The apparatus of claim 23, wherein the means for determining a maximum latency requirement is configured to:
determine a mode of operation for the communication link to be used when transmitting the data packet based on the maximum latency requirement and one or more attributes of a plurality of modes of operation associated with the communication link; and
configure the command code header to indicate the mode of operation to a physical layer circuit to be used for transmitting the data packet.

26. The apparatus of claim 23, wherein the communication link includes a wireless communication link, and wherein the means for determining a maximum latency requirement is configured to:
determine a protocol to be used for transmitting the data packet based on the maximum latency requirement and one or more attributes of a plurality of protocols available for use on the wireless communication link; and
configure the command code header to indicate the protocol to be used for transmitting the data packet,
wherein the plurality of protocols includes a Bluetooth protocol, a protocol associated with a wireless local area network, or a protocol associated with a cellular wireless network.

27. A processor-readable storage medium having one or more instructions which, when executed by at least one processor or state machine of a processing circuit, cause the processing circuit to:
encode virtual general purpose input/output (GPIO) signals or messages into a data packet to be transmitted over a communication link, wherein the virtual GPIO signals represent state information related to a physical GPIO connector;
determine a maximum latency requirement for transmitting the data packet over the communication link;
provide a command code header indicating a packet type to be used for transmitting the data packet over the communication link, wherein the packet type is selected to satisfy the maximum latency requirement; and
transmit the command code header and the data packet over the communication link to at least one peripheral device in a packet that has a type indicated by the command code header.

28. The storage medium of claim 27, wherein the communication link includes a serial bus, and further comprising instructions that cause the processing circuit to:
determine a protocol to be used for transmitting the data packet based on the maximum latency requirement and one or more attributes of a plurality of protocols available for use on the serial bus; and
configure the command code header to indicate the protocol to be used for transmitting the data packet,
wherein the plurality of protocols available for use on the serial bus includes an I2C protocol, an I3C protocol or a radio frequency front-end protocol.

29. The storage medium of claim 27, and further comprising instructions that cause the processing circuit to:
determine a mode of operation for the communication link to be used when transmitting the data packet based on the maximum latency requirement and one or more attributes of a plurality of modes of operation associated with the communication link; and
configure the command code header to indicate the mode of operation to a physical layer circuit to be used for transmitting the data packet.

30. The storage medium of claim 27, wherein the communication link includes a wireless communication link, and further comprising instructions that cause the processing circuit to:
determine a protocol to be used for transmitting the data packet based on the maximum latency requirement and one or more attributes of a plurality of protocols available for use on the wireless communication link; and
configure the command code header to indicate the protocol to be used for transmitting the data packet,
wherein the plurality of protocols includes a Bluetooth protocol, a protocol associated with a wireless local area network, or a protocol associated with a cellular wireless network.
